(19) United States
(12) Patent Application Publication
(10) Pub. No.: US 2025/0030133 A1
(43) Pub. Date: Jan. 23, 2025

(54) LEAD FOR NONAQUEOUS ELECTROLYTE BATTERY

(71) Applicant: SUMITOMO ELECTRIC INDUSTRIES, LTD., Osaka (JP)

(72) Inventors: Kengo GOTO, Tochigi (JP); Ken YANAGIDA, Tochigi (JP)

(73) Assignee: SUMITOMO ELECTRIC INDUSTRIES, LTD., Osaka (JP)

(21) Appl. No.: 18/765,236

(22) Filed: Jul. 6, 2024

(30) Foreign Application Priority Data
Jul. 19, 2023 (JP) 2023-117804

(51) Int. Cl. H01M 50/534; H01M 50/533

(52) U.S. Cl. CPC H01M 50/534; H01M 50/533

(57) ABSTRACT

A lead for a nonaqueous electrolyte battery includes a conductor, and a first electrically insulating resin film and a second electrically insulating resin film disposed at the upper surface and the lower surface of the conductor, respectively. With the conductor being viewed in a direction perpendicular to the upper surface, when an axis extending along selected two sides of the conductor is defined as an X-axis, the selected two sides facing each other, and an axis orthogonal to the X-axis is defined as a Y-axis, the first electrically insulating resin film and the second electrically insulating resin film are disposed so as not to cover two end portions of the conductor in a direction along the Y-axis and are disposed so as to extend along the X-axis and cross and cover, at a portion of the conductor other than the two end portions, the conductor.

### CROSS REFERENCE TO RELATED APPLICATIONS

This application claims priority based on Japanese Patent Application No. 2023-117804 filed on Jul. 19, 2023, and the entire contents of the Japanese patent application are incorporated herein by reference.

### TECHNICAL FIELD

The present disclosure relates to a lead for a nonaqueous electrolyte battery.

### BACKGROUND

Patent literature (Japanese Unexamined Patent Application Publication No. 2022-100451) discloses a film-type battery which includes a film exterior body; an electrode body accommodated in an inside of the film exterior body, and including an electrode; a sheet-shaped terminal electrically connected at one end thereof to the electrode, and extended at the other end thereof to an outside of the film exterior body; a sealed part provided at an edge of the film exterior body on a side thereof from which at least the terminal is extended; and a sealant film integrated with a surface of the terminal on a side thereof opposed to the film exterior body, and welded to the film exterior body at the sealed part. The sealant film includes a notch part formed such that a width in a direction of extension of the terminal of the sealed part is narrower than at other portions.

### SUMMARY

A lead for a nonaqueous electrolyte battery of the present disclosure includes a conductor having a plate shape and having an upper surface and a lower surface each having a rectangular shape, a first electrically insulating resin film disposed at the upper surface of the conductor, and a second electrically insulating resin film disposed at the lower surface of the conductor. With the conductor being viewed in a direction perpendicular to the upper surface, when an axis extending along selected two sides of the conductor is defined as an X-axis, the selected two sides facing each other, and an axis orthogonal to the X-axis is defined as a Y-axis, the first electrically insulating resin film and the second electrically insulating resin film are disposed so as not to cover two end portions of the conductor in a direction along the Y-axis and are disposed so as to extend along the X-axis and cross and cover, at a portion of the conductor other than the two end portions, the conductor and so as to overlap each other when viewed in the direction perpendicular to the upper surface. At least one of the first electrically insulating resin film and the second electrically insulating resin film has a first film layer and a second film layer in order from a location closer to the conductor. The second film layer is disposed such that a portion of a surface of the first film layer is exposed, and a type of a resin in the second film layer differs from a type of a resin in the first film layer.

### BRIEF DESCRIPTION OF THE DRAWINGS

FIG. 1 is an illustration of a battery applying a lead for a nonaqueous electrolyte battery in accordance with an embodiment of the present disclosure.

FIG. 2 is a top view of a lead for a nonaqueous electrolyte battery in accordance with an embodiment of the present disclosure.

FIG. 3A is a cross-sectional view taken along line A-A′ of FIG. 1.

FIG. 3B is another configuration example of a cross-sectional view taken along line A-A′ of FIG. 1.

FIG. 4 is a top view of a lead for a nonaqueous electrolyte battery in accordance with another embodiment of the present disclosure.

FIG. 5 is a top view of a lead for a nonaqueous electrolyte battery in accordance with another embodiment of the present disclosure.

### DETAILED DESCRIPTION

In a nonaqueous electrolyte battery such as a lithium ion secondary battery, when charge and discharge are repeatedly performed, gas may be generated in a container of the nonaqueous electrolyte battery due to a reaction of an electrolyte solution. From the viewpoint of preventing the nonaqueous electrolyte battery from being damaged, it is required to have a configuration in which, when a gas is generated in the nonaqueous electrolyte battery, the gas can be discharged to the outside of the system.

Therefore, an object of the present disclosure is to provide a lead for a nonaqueous electrolyte battery capable of discharging gas generated in the battery to the outside of the container when the lead is applied to the battery.

Embodiments will be described below.

### Description of Embodiments of Present Disclosure

First, embodiments of the present disclosure will be listed and described. In the following description, the same or corresponding elements are denoted by the same reference numerals, and the same description thereof will not be repeated.

(1) A lead for a nonaqueous electrolyte battery according to an aspect of the present disclosure includes a conductor having a plate shape and having an upper surface and a lower surface each having a rectangular shape, a first electrically insulating resin film disposed at the upper surface of the conductor, and a second electrically insulating resin film disposed at the lower surface of the conductor. With the conductor being viewed in a direction perpendicular to the upper surface, when an axis extending along selected two sides of the conductor is defined as an X-axis, the selected two sides facing each other, and an axis orthogonal to the X-axis is defined as a Y-axis, the first electrically insulating resin film and the second electrically insulating resin film are disposed so as not to cover two end portions of the conductor in a direction along the Y-axis and are disposed so as to extend along the X-axis and cross and cover, at a portion of the conductor other than the two end portions, the conductor and so as to overlap each other when viewed in the direction perpendicular to the upper surface. At least one of the first electrically insulating resin film and the second electrically insulating resin film has a first film layer and a second film layer in order from a location closer to the conductor. The second film layer is disposed such that a portion of a surface of the first film layer is exposed, and a type of a resin in the second film layer differs from a type of a resin in the first film layer.

When the lead for a nonaqueous electrolyte battery (hereinafter also referred to as “lead”) according to an aspect of the present disclosure is applied to a nonaqueous electrolyte battery (hereinafter also referred to as “battery”), a conductor having a plate shape and an exterior body which is a container of the battery can be brought into close contact and bonded to each other with an electrically insulating resin film interposed therebetween. Therefore, the lead according to an aspect of the present disclosure has an electrically insulating resin film, and thus a seal portion can be formed along the periphery of the exterior body including the portion where the lead is disposed, and the electrode layered body and the electrolyte can be sealed.

In addition, the second film layer can adjust adhesion between the electrically insulating resin film and the exterior body of the battery.

Specifically, the adhesion between the electrically insulating resin film and the exterior body of the battery can be weakened at the portion where the second film layer and the exterior body of the battery are in contact with each other, as compared with the portion where the first film layer and the exterior body of the battery are in contact with each other.

Therefore, since the electrically insulating resin film has the second film layer, when the pressure inside the exterior body of the battery increases, the battery can be cleaved from the place where the second film layer and the exterior body of the battery are in contact with each other. In addition, since the gas discharge path is formed and the gas in the exterior body of the battery can be discharged to the outside, even when the gas is generated in the exterior body of the battery, the battery can be prevented from being damaged.

(2) In the above (1), the second film layer may have a shorter length in a direction along the X-axis and a shorter length in the direction along the Y-axis than the first film layer. The first film layer and the second film layer may be disposed such that one side of the first film layer and one side of the second film layer coincide with each other in terms of positions on the Y-axis.

The length of the conductor along the X-axis and the length of the conductor in the direction along the Y-axis are made shorter in the second film layer than in the first film layer, whereby the exposed area of the first film layer can be increased. Therefore, when the electrically insulating resin film is applied to a battery, the working pressure, which is the pressure at which the gas in the exterior body is discharged to the outside, can be adjusted while particularly increasing the adhesion between the exterior body of the battery and the electrically insulating resin film.

By disposing the first film layer and the second film layer such that one side of the first film layer and one side of the second film layer coincide with each other in terms of positions on the Y-axis, one side of the second film layer can be disposed in the exterior body of the battery when the lead is applied to the battery. Therefore, when the pressure in the exterior body increases, one side of the second film layer can directly contact the gas generated in the exterior body, and the battery is easily cleaved. Therefore, when the pressure in the exterior body increases, the responsiveness to the pressure is increased, and when the pressure in the exterior body reaches a desired pressure, the gas in the exterior body can be discharged to the outside.

(3) In the above (1), a length obtained by subtracting a length of the second film layer in the direction along the Y-axis from a length of the first film layer in the direction along the Y-axis may be 0 mm to 1 mm. A length of the second film layer in the direction along the X-axis may be shorter than a length of the first film layer in the direction along the X-axis. The first film layer and the second film layer may be disposed such that one side of the first film layer and one side of the second film layer coincide with each other in terms of positions on the Y-axis.

When the length of the second film layer in a direction along the Y-axis is the same as the length of the first film layer in the direction along the Y-axis, the second film layer can be disposed to connect the inside and the outside of the exterior body of the battery. As a result, when the pressure in the exterior body increases, the working pressure, which is the pressure at which the gas in the exterior body is discharged to the outside, can be reduced.

(4) In the above (1), two sides of the second film layer may have different lengths, the two sides being located one each at two ends of the second film layer in the direction along the Y-axis. The first film layer and the second film layer may be disposed such that one side of the first film layer and one side of the second film layer coincide with each other in terms of positions on the Y-axis.

In the second film layer, the lengths of the sides of the two ends in a direction along the Y-axis of the conductor are different from each other, and thus it is possible to adjust the responsiveness to the pressure in the exterior body and the easiness of the release of the gas in the exterior body to the outside.

(5) In any one of the above (1) to (4), the first film layer may contain, as a resin, one or more types of resins selected from a polyolefin resin, a polyester resin, a polystyrene resin, and a polyvinyl chloride resin.

When the first film layer contains, as a resin, one or more types of resins selected from a polyolefin resin, a polyester resin, a polystyrene resin, and a polyvinyl chloride resin, the adhesion between the electrically insulating resin film and the exterior body can be enhanced.

(6) In any one of the above (1) to (5), the second film layer may contain, as a resin, one or more types of resins selected from a polyimide resin, a polyester resin, and a fluorine-based resin.

When the second film layer contains, as a resin, one or more types of resins selected from a polyimide resin, a polyester resin, and a fluorine-based resin, the adhesion between the electrically insulating resin film and the exterior body can be easily adjusted.

### Details of Embodiments of Present Disclosure

A specific example of a lead for a nonaqueous electrolyte battery according to one embodiment of the present disclosure (hereinafter referred to as “the embodiment”) will be described below with reference to the drawings. The present invention is not limited to these examples, but is defined by the scope of the claims, and is intended to include all modifications within the meaning and scope equivalent to the scope of the claims.

In the present specification, the first, second, and the like may be added to the names of members, such as a first electrically insulating resin film, a second electrically insulating resin film, a first film layer, and a second film layer. The terms “first”, “second”, and the like are used only to distinguish the respective members and to prevent confusion in the description, and do not represent arrangement, priority, and the like. Therefore, when there is no particular fear of confusion or when the layers are collectively shown, they can be simply referred to as an electrically insulating resin film or a film layer.

### Lead for Nonaqueous Electrolyte Battery

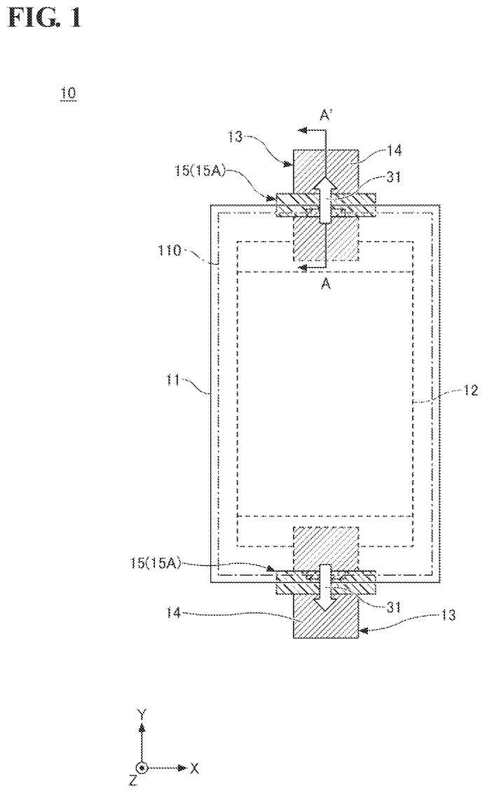

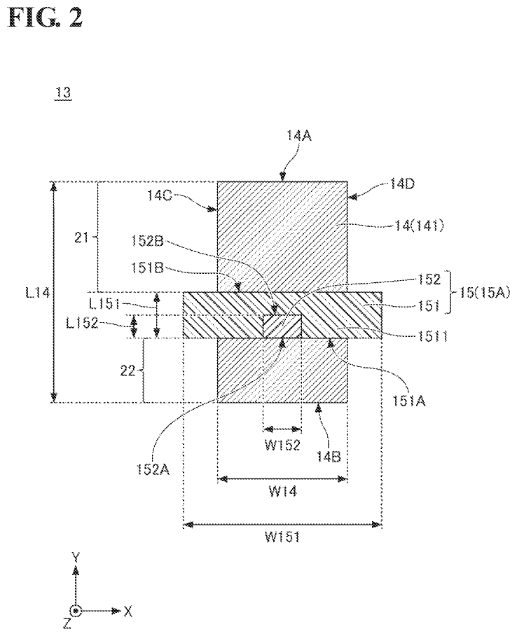

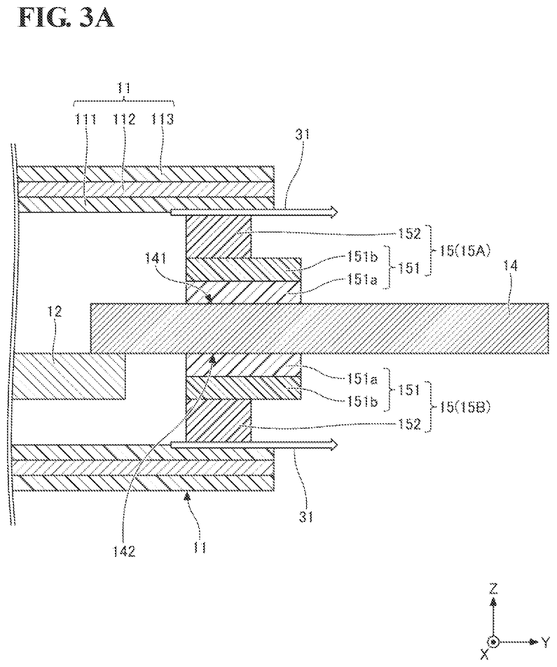

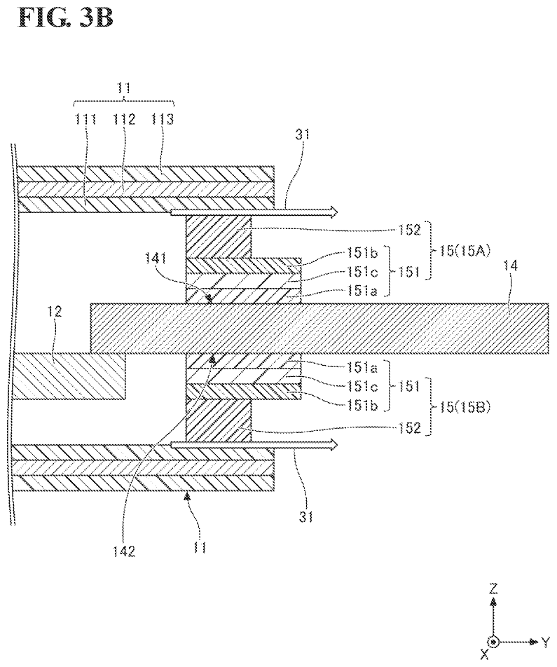

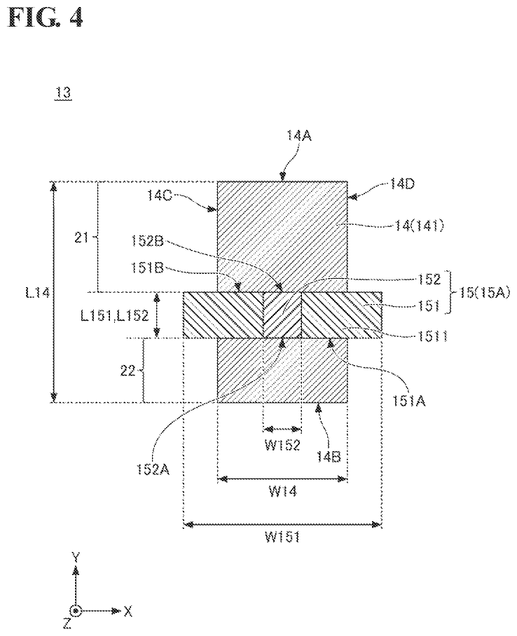

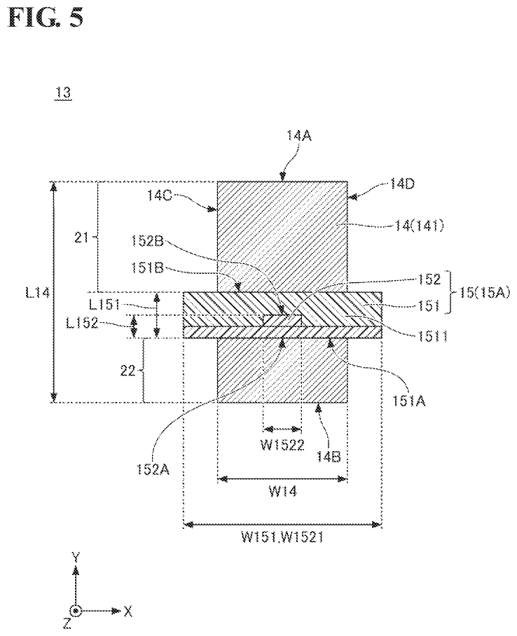

FIG. 1 is an illustration of a configuration example in which the lead for the nonaqueous electrolyte battery of the embodiment is applied to a nonaqueous electrolyte battery. FIG. 2 is an illustration of the lead for the nonaqueous electrolyte battery of the embodiment, as viewed in a direction perpendicular to an upper surface of a conductor. FIG. 3A shows a cross-sectional view taken along line A-A′ of FIG. 1. FIG. 3B shows another configuration example corresponding to a cross-sectional view taken along line A-A′ of FIG. 1. FIGS. 4 and 5 are illustrations of other configuration examples of leads for the nonaqueous electrolyte battery of the embodiment. Since FIGS. 3B, 4, and 5 are modifications of the lead of the embodiment, the description will be made mainly using FIGS. 1, 2, and 3A, and FIGS. 3B, 4, and 5 will be used as necessary.

A Z-axis in FIGS. 1, 2, 3A, 3B, 4, and 5 is an axis along the thickness of the conductor and the electrically insulating resin film of the lead of the embodiment.

A lead 13 of the embodiment can be applied to a nonaqueous electrolyte battery. Therefore, after describing a battery to which lead 13 of the embodiment can be applied, lead 13 of the embodiment will be described in detail.

### (1) Regarding Battery

A configuration example of a battery to which lead 13 of the embodiment is applied will be described with reference to FIG. 1. As shown in FIG. 1, a battery 10 can include an exterior body 11, an electrode layered body 12 in which a positive electrode, a separator, and a negative electrode are stacked and which is impregnated with an electrolyte solution, and leads 13, which is connected to electrode layered body 12, according to an embodiment of the present disclosure.

### (Exterior Body)

Exterior body 11 is a container that accommodates and seals electrode layered body 12 and the electrolyte. At least one resin layer can be disposed on a surface of exterior body 11 facing electrode layered body 12 so that exterior body 11 can be thermally welded.

Exterior body 11 is a so-called laminate film, and can have a structure in which a first resin layer 111, a metal layer 112, and a second resin layer 113 are laminated, for example, as shown in FIG. 3A.

The type of resin used for first resin layer 111 is not particularly limited, and a thermoplastic resin can be suitably used. First resin layer 111 can be formed of the same type of thermoplastic resin as that of a first film layer 151, which will be described later, and thus the description thereof will be omitted.

Metal layer 112 is a layer for improving airtightness and can be a layer containing a metal material such as aluminum, iron, or stainless.

Second resin layer 113 is a layer for enhancing durability and impact resistance, and for example, a thermoplastic resin can be suitably used as in first resin layer 111.

As shown by a one dot chain line in FIG. 1, a seal portion 110 is formed at the periphery of exterior body 11, and electrode layered body 12 and the electrolyte are sealed by seal portion 110.

### (2) Regarding Lead

Lead 13 of the embodiment is also called a tab lead or the like, and includes a conductor 14 and an electrically insulating resin film 15.

Each member of lead 13 will be described.

### (2-1) Conductor

Conductor 14 is a member for connecting electrode layered body 12 disposed inside exterior body 11 and the device disposed outside exterior body 11. Conductor 14 can have a plate shape, and an upper surface 141 and a lower surface 142 (see FIG. 3A) have rectangular shapes. As shown in FIG. 2, upper surface 141 of conductor 14 can have an oblong shape or square shape having two sides 14A and 14B facing each other and sides 14C and 14D intersecting sides 14A and 14B. However, the rectangular shape, the oblong shape, and the square shape do not mean geometrically strict shapes, and conductor 14 can have a concave portion, a convex portion, or the like, necessary for connection to electrode layered body 12 or the device on the outside, for example.

In the following description, an axis along side 14A and side 14B, which are selected two sides facing each other when conductor 14 is viewed in a direction perpendicular to upper surface 141, is referred to as the X-axis. An axis orthogonal to the X-axis is defined as the Y-axis.

The material of conductor 14 is not particularly limited, and for example, various materials used for a conductor of the lead for the nonaqueous electrolyte battery can be used. Examples of the material of conductor 14 include metal materials such as aluminum, titanium, nickel, copper, aluminum alloys, titanium alloys, nickel alloys, and copper alloys, and materials obtained by plating these metal materials with nickel, gold, or the like.

### (2-2) Electrically Insulating Resin Film

Electrically insulating resin film 15 includes a first electrically insulating resin film 15A disposed on upper surface 141 of conductor 14 and a second electrically insulating resin film 15B disposed on lower surface 142 of conductor 14 (see FIG. 3A). As shown in FIGS. 2 and 3A, first electrically insulating resin film 15A and second electrically insulating resin film 15B are disposed on upper surface 141 and lower surface 142 so as to expose two end portions of conductor 14 in a direction along the Y-axis, that is, two end portions including side 14A and side 14B, without covering the two end portions. In addition, on upper surface 141 and lower surface 142, first electrically insulating resin film 15A and second electrically insulating resin film 15B are disposed to cross and cover conductor 14 in a direction along the X-axis at the middle portion of conductor 14, which is a portion other than the two end portions in a direction along the Y-axis.

First electrically insulating resin film 15A and second electrically insulating resin film 15B are disposed such that first electrically insulating resin film 15A disposed on upper surface 141 and second electrically insulating resin film 15B disposed on lower surface 142 overlap each other when viewed in the direction perpendicular to upper surface 141.

Upper surface 141 and lower surface 142 of conductor 14 are the surfaces facing exterior body 11 of battery 10 when battery 10 is manufactured.

The two end portions of conductor 14 in a direction along the Y-axis mean a first end portion region 21 including side 14A and a second end portion region 22 including side 14B as shown in FIG. 2. The middle portion is a portion located between first end portion region 21 and second end portion region 22.

First end portion region 21 is, for example, a portion exposed to the outside of exterior body 11 when lead 13 is applied to a battery, and the size thereof can be selected so as to be connected to the device on the outside. In addition, second end portion region 22 is a portion which is located, for example, inside exterior body 11 and is connected to electrode layered body 12 when lead 13 is applied to a battery, and the size of second end portion region 22 can be selected so that second end portion region 22 can be connected to electrode layered body 12. First end portion region 21 and second end portion region 22 may have the same size such as an area or may have different sizes.

When lead 13 of the embodiment is applied to a battery, conductor 14 having a plate shape and exterior body 11 of battery 10 can be brought into close contact and bonded to each other with electrically insulating resin film 15 interposed therebetween. Therefore, lead 13 of the embodiment has electrically insulating resin film 15, so that seal portion 110 (see FIG. 1) can be formed along the periphery of exterior body 11 including the portion where lead 13 is disposed, to seal electrode layered body 12 and the electrolyte.

At least one electrically insulating resin film 15 of first electrically insulating resin film 15A and second electrically insulating resin film 15B includes first film layer 151 and a second film layer 152 in order from a location closer to conductor 14 (see FIGS. 2 and 3A). That is, at least one of first electrically insulating resin film 15A and second electrically insulating resin film 15B has a structure in which first film layer 151 and second film layer 152 are sequentially laminated on conductor 14.

In FIG. 3A, first electrically insulating resin film 15A and second electrically insulating resin film 15B both have first film layer 151 and second film layer 152, but the present invention is not limited to such a configuration. For example, only first electrically insulating resin film 15A can include first film layer 151 and second film layer 152, and second electrically insulating resin film 15B can include only first film layer 151.

### (First Film Layer)

First film layer 151 is a layer for enabling thermal welding with exterior body 11 when applied to a battery. Therefore, first film layer 151 preferably contains a thermoplastic resin as the resin. As the thermoplastic resin, for example, one or more selected from a polyolefin resin, a polyester resin, a polystyrene resin, a polyvinyl chloride resin, and the like can be used. Examples of the polyolefin resin include polyethylene, polypropylene, and an acid-modified polyolefin resin such as acid-modified polyethylene and acid-modified polypropylene. Examples of the polyester resin include a polyethylene terephthalate resin. Examples of the acid-modified polyolefin include maleic anhydride-modified polyolefin.

First film layer 151 can contain, as a resin, one or more types of resins selected from a polyolefin resin, a polyester resin, a polystyrene resin, a polyvinyl chloride resin, and the like, and thus, the adhesion between electrically insulating resin film 15 and the exterior body can be improved.

First film layer 151 can be composed of two or more layers as shown in FIGS. 3A and 3B. First film layer 151 can include a base layer 151a and a surface layer 151b as shown in FIG. 3A. First film layer 151 can also include base layer 151a, an intermediate layer 151c, and surface layer 151b, as shown in FIG. 3B.

When first film layer 151 has a plurality of layers, each layer can be a layer for the purpose of adjusting the adhesion to conductor 14 and exterior body 11, adjusting the strength of the layer derived from first film layer 151 after being bonded to exterior body 11, and the like. Therefore, the material of each layer can be selected according to the intended function and the like. When first film layer 151 has a plurality of layers, for example, the thermoplastic resin described above can be suitably used for each layer. The material of first film layer 151, the number of layers constituting first film layer 151, and the like may be different between first electrically insulating resin film 15A and second electrically insulating resin film 15B.

First film layer 151 can have, for example, a rectangular shape when viewed in the direction perpendicular to upper surface 141 of conductor 14. However, the rectangular shape here is not limited to a geometrically strict meaning, and for example, the corners of the apexes may be processed to be curved.

First film layer 151 is disposed on upper surface 141 and lower surface 142 of conductor 14, so that the two end portions of conductor 14 in a direction along the Y-axis of conductor 14 are exposed and first film layer 151 covers entire upper surface 141 along sides 14A and 14B at the middle portion other than the two end portions of conductor 14. That is, first film layer 151 is disposed so as to expose first end portion region 21 and second end portion region 22 of conductor 14. Therefore, a length L151 of first film layer 151 in a direction along the Y-axis is shorter than a length L14 of conductor 14 in a direction along the Y-axis.

A length W151 of first film layer 151 in a direction along the X-axis is longer than a length W14 of conductor 14 in a direction along the X-axis. Therefore, first film layer 151 can be disposed so as to protrude from two sides of conductor 14 in a direction along the X-axis. First film layer 151 disposed on upper surface 141 of conductor 14 and first film layer 151 disposed on lower surface 142 of conductor 14 can be adhered to each other at a portion protruding from conductor 14. First film layer 151 is disposed in a direction along the X-axis so as to protrude from two sides of conductor 14, and first film layer 151 disposed on upper surface 141 and lower surface 142 of conductor 14 is bonded to each other, whereby the adhesion between conductor 14 and first film layer 151 is increased.

The shapes of first film layers 151 disposed on upper surface 141 and lower surface 142 of conductor 14 may be the same or different. However, from the viewpoint of bonding first film layers 151 to each other at the portions protruding from conductor 14 as described above, first film layers 151 disposed on upper surface 141 and lower surface 142 of conductor 14 preferably have the same shape.

First film layer 151 may be welded to conductor 14 or may be attached to conductor 14 by an adhesive or the like.

### (Second Film Layer)

Second film layer 152 is disposed such that a portion of the surface of first film layer 151 is exposed, and a type of a resin in second film layer 152 differs from a type of a resin in first film layer 151 can be used. When first film layer 151 includes a plurality of layers, a type of a resin in second film layer 152 differs from a type of a resin in surface layer 151b which is the layer closest to second film layer 152 in first film layer 151 can be used. First film layer 151 and second film layer 152 may be attached to each other by an adhesive.

Second film layer 152 can adjust adhesion between electrically insulating resin film 15 and exterior body 11 of battery 10.

Specifically, the adhesion between electrically insulating resin film 15 and exterior body 11 of battery 10 can be weakened at the portion where second film layer 152 and exterior body 11 of battery 10 are in contact with each other, as compared to the portion where first film layer 151 and exterior body 11 of battery 10 are in contact with each other.

Therefore, since electrically insulating resin film 15 includes second film layer 152, when the pressure inside exterior body 11 of battery 10 increases, the battery can be cleaved from the place where second film layer 152 and exterior body 11 of battery 10 are in contact with each other. Further, as shown by a block arrow 31 in FIGS. 1 and 3A, a gas discharge path is formed, and the gas in exterior body 11 of battery 10 can be discharged to the outside, and therefore, even when the gas is generated in exterior body 11 of battery 10, battery 10 can be prevented from being damaged or the like.

Second film layer 152 can adjust the adhesion between exterior body 11 and electrically insulating resin film 15 by selecting the material, shape, and area thereof.

Therefore, second film layer 152 can be formed of a different type of resin from first film layer 151. By using a resin of a type different from that of first film layer 151 for second film layer 152, the adhesion between electrically insulating resin film 15 and exterior body 11 of battery 10 can be adjusted.

Second film layer 152 is preferably made of a resin that is less likely to be melted than first film layer 151 when exterior body 11 is thermally welded. Therefore, the resin used for second film layer 152 is preferably a resin having a higher melting point than first film layer 151, for example. Second film layer 152 can include, for example, one or more selected from polyimide resin, polyester resin, and fluorine-based resin as a resin.

Example of the polyester resin include a polyethylene terephthalate resin.

As the fluorine-based resin, for example, one or more kinds selected from polytetrafluoroethylene (PTFE), tetrafluoroethylene-perfluoroalkyl vinyl ether copolymer (PFA), polyvinylidene fluoride (PVDF), ethylene-tetrafluoroethylene copolymer (ETFE), tetrafluoroethylene-hexafluoropropylene copolymer (FEP), and the like can be used.

Second film layer 152 contains, as a resin, one or more types of resins selected from a polyimide resin, a polyester resin, and a fluorine-based resin, and thus the adhesion between electrically insulating resin film 15 and the exterior body can be easily adjusted.

In addition, second film layer 152 can have a smaller area than first film layer 151. Thus, second film layer 152 can be disposed such that a portion of the surface of first film layer 151 is exposed, i.e., such that an exposure portion 1511 is formed in which first film layer 151 is exposed. By disposing second film layer 152 such that a portion of the surface of first film layer 151 is exposed, when lead 13 is applied to a battery, the adhesion between electrically insulating resin film 15 and exterior body 11 of battery 10 can be adjusted.

In the case where each of first electrically insulating resin film 15A and second electrically insulating resin film 15B has second film layer 152, the material, shape, and area of second film layer 152 may be different or the same between first electrically insulating resin film 15A and second electrically insulating resin film 15B.

A configuration example of the shape of second film layer 152 will be described below.

### First Configuration Example

For example, as shown in FIG. 2, second film layer 152 may have a shorter length in a direction along the X-axis and a shorter length in the direction along the Y-axis than first film layer 151.

That is, length L151 of first film layer 151 in a direction along the Y-axis can be shorter than a length L152 of second film layer 152 in a direction along the Y-axis (L151>L152). Further, length W151 of first film layer 151 in a direction along the X-axis of conductor 14 can be shorter than a length W152 of second film layer 152 in a direction along the X-axis (W151>W152).

The length of second film layer 152 in a direction along the X-axis and the Y-axis are made shorter than those of first film layer 151, whereby the exposed area of first film layer 151 can be increased. Therefore, when lead 13 is applied to battery 10, the working pressure, which is the pressure at which the gas in exterior body 11 is discharged to the outside, can be adjusted while particularly increasing the adhesion between exterior body 11 of battery 10 and electrically insulating resin film 15.

First film layer 151 and second film layer 152 can be disposed such that one side of first film layer 151 and one side of second film layer 152 coincide with each other in terms of positions on the Y-axis.

In the embodiment shown in FIG. 2, a side 152A of second film layer 152 and a side 151A of first film layer 151 are disposed such that their positions coincide with each other in terms of positions on the Y-axis. In the case of the configuration example, a side 152B of second film layer 152 and a side 151B of first film layer 151 do not coincide with each other in terms of positions on the Y-axis.

For example, when lead 13 is applied to a battery, in the case that second end portion region 22 of conductor 14 is disposed so as to be positioned inside exterior body 11, side 152A of second film layer 152 and side 151A of first film layer 151 are disposed inside exterior body 11. Therefore, when the pressure in exterior body 11 increases, side 152A, which is one side of second film layer 152, can directly contact the gas generated in exterior body 11, and the battery is easily cleaved. Therefore, when the pressure in exterior body 11 increases, the responsiveness to the pressure is increased, and when the pressure in exterior body 11 reaches a desired pressure, the gas in exterior body 11 can be discharged to the outside.

### Second Configuration Example

For example, as shown in FIG. 4, the length (L151-L152) obtained by subtracting length L152 of second film layer 152 in the direction along the Y-axis from length L151 of first film layer 151 in the direction along the Y-axis can be set to be 0 mm to 1 mm.

That is, for example, as shown in FIG. 4, L151 can be equal to L152, and length L152 of second film layer 152 can be made shorter than length L151 of first film layer 151 within a range up to 1 mm.

In this case, length W152 of second film layer 152 in a direction along the X-axis can be shorter than length W151 of first film layer 151 in a direction along the X-axis, i.e., W152<W151.

When lead 13 is applied to a battery, as shown in FIG. 1, exterior body 11 is disposed to cover a portion of first film layer 151 in a direction along the Y-axis. Therefore, when length L152 of second film layer 152 in a direction along the Y-axis is set to be the same as length L151 of first film layer 151, second film layer 152 can be disposed so as to connect the inside and outside of exterior body 11 of battery 10. As a result, when the pressure in exterior body 11 increases, the working pressure, which is the pressure at which the gas in exterior body 11 is discharged to the outside, can be reduced.

The effect in the case of L151>L152 is as described above.

First film layer 151 and second film layer 152 can be disposed such that one side of first film layer 151 and one side of second film layer 152 coincide with each other in terms of positions on the Y-axis.

In the embodiment shown in FIG. 4, side 152A of second film layer 152 and side 151A of first film layer 151 are disposed such that their positions coincide with each other in terms of positions on the Y-axis.

Since such an effect is the same as that in the first configuration example, the description of the effect will be omitted.

### Third Configuration Example

For example, as shown in FIG. 5, two sides of second film layer 152 can have different lengths, the two sides being located one each at two ends of second film layer 152 in the direction along the Y-axis.

In the example shown in FIG. 5, a length W1521 of side 152A and a length W1522 of side 152B of second film layer 152 have different lengths, the two sides being located one each at two ends of second film layer 152 in the direction along the Y-axis, and W1522<W1521.

By configuring two sides of second film layer 152 have different lengths, the two sides being located one each at two ends of second film layer 152 in the direction along the Y-axis, the responsiveness to the pressure in exterior body 11 and the ease of release of the gas in exterior body 11 to the outside can be adjusted.

When length W1521 of side 152A disposed in exterior body 11 is longer than length W1522 of side 152B in the case of application to a battery, the adhesion of electrically insulating resin film 15 in exterior body 11 is smaller at the end portion in contact with exterior body 11 than in the case where the side 152A and the side 152B are both equal to length W1522 of side 152B. Thus, when the pressure in exterior body 11 increases, the working pressure, which is the pressure at which the gas in exterior body 11 is discharged to the outside, can be reduced.

Length W1521 of side 152A and length W1522 of side 152B can be selected according to the required working pressure, and are not particularly limited.

Length L152 of second film layer 152 in a direction along the Y-axis is not particularly limited. For example, as in the case of the first configuration example, length L152 of second film layer 152 in a direction along the Y-axis of conductor 14 may be shorter than length L151 of first film layer 151 in a direction along the Y-axis of conductor 14 (L151>L152). In addition, as in the case of the second configuration example, the length obtained by subtracting length L152 of second film layer 152 in a direction along the Y-axis from length L151 of first film layer 151 in a direction along the Y-axis can be set to 0 mm to 1 mm.

First film layer 151 and second film layer 152 can be disposed such that one side of first film layer 151 and one side of second film layer 152 coincide with each other in terms of positions on the Y-axis.

In the embodiment shown in FIG. 5, side 152A of second film layer 152 and side 151A of first film layer 151 are disposed such that their positions coincide with each other in terms of positions on the Y-axis.

Since such an effect is the same as that in the first configuration example, the description of the effect will be omitted.

### EXAMPLE

The present invention will be described below with reference to specific examples, but the present invention is not limited to these examples.

### (Evaluation Method)

First, methods for evaluating leads and batteries produced in the following experimental examples will be described.

A tube was connected to exterior body 11 of the battery produced in the following experimental example, and air was supplied to the interior of exterior body 11 at a constant pressure and flow rate through the tube. The internal pressure of the tube at this time was measured, and the pressure at the time when the air was discharged from exterior body 11 and the increase in the internal pressure of the tube stopped was evaluated as the working pressure.

Further, soap water was sprayed around exterior body 11 of the battery, and a portion where air was discharged was observed.

The lead and battery in each experimental example will be described below.

Experimental Examples 1 to 3 are examples, and experimental example 4 is a comparative example. In all of Experimental Examples 1 to 4, first electrically insulating resin film 15A and second electrically insulating resin film 15B had the same configuration.

### Experimental Example 1

Lead 13 shown in FIGS. 2 and 3A was produced, and battery 10 using two leads 13 was produced. First film layer 151 has two layers, that is, base layer 151a containing maleic anhydride-modified polypropylene and surface layer 151b containing polypropylene, in this order from the position close to conductor 14.

As exterior body 11, a laminate film in which first resin layer 111 and second resin layer 113 were polypropylene films and metal layer 112 was an aluminum foil was used.

In this experimental example, the positions of lead 13 and exterior body 11 were adjusted so that second film layer 152 was completely covered with exterior body 11.

Then, as shown in FIG. 1, exterior body 11 was disposed to cover a portion of electrically insulating resin film 15 of lead 13 and was thermally welded to form seal portion 110. At this time, a tube for supplying air when the evaluation was performed was installed on one side where lead 13 was not disposed.

The battery was produced for evaluation, and electrode layered body 12 was not disposed in exterior body 11.

The obtained battery was evaluated as described above, and it was found that the working pressure was 0.30 MPa and air was discharged from the portion of lead 13 where second film layer 152 was provided.

### Experimental Example 2

A lead and a battery were produced and evaluated under the same conditions as in Experimental Example 1, except that lead 13 was formed into the shape shown in FIG. 4.

Lead 13 is configured so that length L151 of first film layer 151 and length L152 of second film layer 152 in a direction along the Y-axis are the same.

In the battery produced in this experimental example, the positions of lead 13 and exterior body 11 were adjusted so that only a portion of second film layer 152 was covered with exterior body 11.

The obtained battery was evaluated as described above, and it was found that the working pressure was 0.05 MPa and air was discharged from the portion of lead 13 where second film layer 152 was provided.

### Experimental Example 3

A lead and a battery were produced and evaluated under the same conditions as in Experimental Example 1 except that lead 13 was formed into the shape shown in FIG. 5.

Length L152 of second film layer 152 in a direction along the Y-axis is shorter than length L151 of first film layer 151 in a direction along the Y-axis of conductor 14, that is, L151>L152.

In the battery produced in the experimental example, the positions of lead 13 and exterior body 11 were adjusted so that second film layer 152 was completely covered with exterior body 11.

The obtained battery was evaluated as described above, and it was confirmed that the working pressure was 0.20 MPa and air was discharged from the portion of lead 13 where second film layer 152 was provided. [Experimental Example 4]A lead and a battery were produced and evaluated under the same conditions as in Experimental Example 1 except that electrically insulating resin film 15 was composed of only first film layer 151 and second film layer 152 was not provided.

When the above evaluation was performed on the obtained battery, no air was discharged even after reaching 0.5 MPa, so the evaluation was stopped at this pressure.

What is claimed is:

1. A lead for a nonaqueous electrolyte battery, the lead comprising:
a conductor having a plate shape and having an upper surface and a lower surface each having a rectangular shape;
a first electrically insulating resin film disposed at the upper surface of the conductor; and
a second electrically insulating resin film disposed at the lower surface of the conductor,
wherein, with the conductor being viewed in a direction perpendicular to the upper surface, when an axis extending along selected two sides of the conductor is defined as an X-axis, the selected two sides facing each other, and an axis orthogonal to the X-axis is defined as a Y-axis,
the first electrically insulating resin film and the second electrically insulating resin film are disposed so as not to cover two end portions of the conductor in a direction along the Y-axis and are disposed so as to extend along the X-axis and cross and cover, at a portion of the conductor other than the two end portions, the conductor and so as to overlap each other when viewed in the direction perpendicular to the upper surface,
wherein at least one of the first electrically insulating resin film and the second electrically insulating resin film has a first film layer and a second film layer in order from a location closer to the conductor, and
wherein the second film layer is disposed such that a portion of a surface of the first film layer is exposed, and a type of a resin in the second film layer differs from a type of a resin in the first film layer.

2. The lead for the nonaqueous electrolyte battery according to claim 1,
wherein the second film layer has a shorter length in a direction along the X-axis and a shorter length in the direction along the Y-axis than the first film layer, and
wherein the first film layer and the second film layer are disposed such that one side of the first film layer and one side of the second film layer coincide with each other in terms of positions on the Y-axis.

3. The lead for the nonaqueous electrolyte battery according to claim 1,
wherein a length obtained by subtracting a length of the second film layer in the direction along the Y-axis from a length of the first film layer in the direction along the Y-axis is 0 mm to 1 mm,
wherein a length of the second film layer in the direction along the X-axis is shorter than a length of the first film layer in the direction along the X-axis, and
wherein the first film layer and the second film layer are disposed such that one side of the first film layer and one side of the second film layer coincide with each other in terms of positions on the Y-axis.

4. The lead for the nonaqueous electrolyte battery according to claim 1,
wherein two sides of the second film layer have different lengths, the two sides being located one each at two ends of the second film layer in the direction along the Y-axis, and
wherein the first film layer and the second film layer are disposed such that one side of the first film layer and one side of the second film layer coincide with each other in terms of positions on the Y-axis.

5. The lead for the nonaqueous electrolyte battery according to claim 1,
wherein the first film layer contains, as a resin, one or more types of resins selected from a polyolefin resin, a polyester resin, a polystyrene resin, and a polyvinyl chloride resin.

6. The lead for the nonaqueous electrolyte battery according to claim 1,
wherein the second film layer contains, as a resin, one or more types of resins selected from a polyimide resin, a polyester resin, and a fluorine-based resin.
